(19) United States
(12) Patent Application Publication
(10) Pub. No.: US 2006/0145662 A1
(43) Pub. Date: Jul. 6, 2006

(54) Hierarchical battery potential equalizing device

(75) Inventors: Yi-Shuo Huang, Hsinchu County (TW); Chun-Hsien Lee, Hsinchu County (TW); Tain-Syh Luor, Hsinchu County (TW)

Correspondence Address: BACON & THOMAS, PLLC, 625 SLATERS LANE, FOURTH FLOOR, ALEXANDRIA, VA, 22314, US

(73) Assignee: Industrial Technology Research Institute, Hsin Chu (TW)

(21) Appl. No.: 11/245,155

(22) Filed: Oct. 7, 2005

(30) Foreign Application Priority Data
Dec. 30, 2004 (TW) 093141498

(51) Int. Cl. H02J 7/00

(52) U.S. Cl. 320/116

(57) ABSTRACT

The present invention provides a hierarchical battery potential equalizing device to equalize the voltage of a plurality of serial batteries. The batteries are divided into a plurality of groups, one potential equalizer is provided for each group to make potential equalization among batteries, and at least one potential equalizer is provided for different groups to make potential equalization among groups. Wherein the potential equalizers have a hierarchical architecture, the first level of potential equalizers of the hierarchical architecture are respectively corresponding to one group to make potential equalization, and the other levels of potential equalizers make potential equalization among groups.

### BACKGROUND OF THE INVENTION

1. Field of the Invention

The present invention relates to a potential equalizing device for battery voltage, and more particularly to a hierarchical battery potential equalizing device and circuit structure.

2. Description of the Related Art

In most applications of battery, batteries are used in serial connection except for those few electronic equipments having lower voltage and lower energy consumption. That is because the voltage of current single battery is not high, and the loss of electric energy is higher when it is used alone. For example, under the same load power, the voltage and capacity of a system of four serial batteries is four times that a system of single battery, and the output current needed is only one fourth of a single battery system, so that the transferring loss of a line is lower by approximately a factor of 16. Although it is advantageously to use a serial battery set, if we just regard it as a “single battery” having high voltage and big capacity without consideration of the property difference among single batteries, then it does not achieve the total performance as expected in actual applications.

Secondary batteries have properties of charging/discharging capacity, charging transforming efficiency, initial amount of electricity, internal resistance, etc. These properties are not completely the same even for the same batch of production. Thus, at the initial stage of direct use of these serial single batteries having slight difference, the user does not feel any problem in performance, however, the user gradually finds that the available time of battery power becomes shorter as the times of repetitive charging/discharging increase, and the user needs to recharge the battery more frequently. Furthermore, under charging/discharging, the temperature of a battery set is much higher than a new battery. This is because the difference among single batteries is not big at the initial stage of the use of the battery set, however the difference becomes bigger as the times of charging/discharging increase. This vicious circle makes a single battery with bad property get worse, so that the performance of a whole battery set is restricted to these single batteries with worse property. Thus, for solving the abovementioned problems in the industry currently, we must monitor the voltage of respective single battery in a serial battery set, and use a battery potential equalizer to equalize the non-uniformity of energy storing among single batteries due to the difference of property, thereby increasing the actual capacity of charging/discharging of a battery set and prolonging the lifetime of usage.

The terminal voltage of each battery of a serial battery set is related to the battery capacity and the amount of electricity stored therein. Making each battery voltage equal is an action of energy transforming, in other words, it consumes the energy of a battery with higher voltage or transforming the energy to a battery with lower voltage. Depending on whether the energy is consumed, the battery potential equalizing device can be divided into consumptive and non-consumptive battery potential equalizing devices: the former one transforms the energy of a battery with higher voltage into heat energy using switched resistor loads or switched buffering capacitors, achieving voltage equalization. The latter one uses switched direct-current transformers to deliver energy among batteries, and it will theoretically achieve lossless delivery if we omit the loss of switching. Depending on whether the total battery energy transforming is involved in the energy transforming, the non-consumptive battery potential equalizing device can be further divided into total amount of electricity distribution and unit amount of electricity distribution: the former one will extract or input the total energy of serial batteries to equalize respective battery voltage. The latter one will achieve the equalization via the energy delivery between adjoining single batteries. Wherein the total amount of electricity distribution is called a distributed battery potential equalizing device if those electricity transformers it used are independent to each other, relatively, the total amount of electricity distribution is called a centralized battery potential equalizing device if it uses single electricity transformer.

FIG. 1 shows a circuit structure for a consumptive battery potential equalizing device according to the prior art, which consumes the energy of the battery 3 with higher terminal voltage at the load resistor of respective potential equalizers 2 by switching, although the circuit structure is simple, it needs to detect the terminal voltage of respective battery and has the problem of heat dissipation. In a non-consumptive battery potential equalizing technology, FIG. 2 shows a circuit structure for a battery potential equalizing device based on unit amount of electricity distribution, which basically uses two adjoining unit batteries as the equalizing mechanism to transfer the energy of one of these two batteries with higher terminal voltage to the other with lower terminal voltage. Although the circuit structure has module expansibility, the number of the potential equalizers 2 is more than the number of the charging batteries 3 by one and the equalizing speed is slower. FIG. 3 shows a circuit structure for a distributed battery potential equalizing device based on total amount of electricity distribution, wherein all direct-current transformer circuits are independent one another. When the battery voltage is different from the average value, it will enable the direct-current transformer circuits to extract out excess battery energy and divert to a serial battery set, or provide additional energy to the battery 3 with lower voltage by a serial battery set. Although the degree of freedom of control is high, it has the following disadvantages that it must determine the action of these transformers relying on a centralized controlling circuit, and the circuit size is bulky and the cost is high. FIG. 4 shows a circuit structure for a centralized battery potential equalizing device based on total amount of electricity distribution, which uses single direct-current transformer as an individual battery voltage equalizing mechanism in a serial battery set. Theoretically, the centralized voltage equalizing circuit size is smaller and the cost is lower, however, the difficulty of matching design is higher and it does not has module expansibility. In addition, when the number of serial batteries increases, the design for a battery potential equalizing circuit based on total amount of electricity distribution is not easy and it is not easy to increase the efficiency.

### SUMMARY OF THE INVENTION

An object of the invention is to provide a battery potential equalizing device suitable for use in serial batteries with high number of batteries.

Another object of the invention is to provide a hierarchical battery potential equalizing circuit structure suitable for use in serial batteries with high number of batteries.

For achieving these above objects, the hierarchical battery potential equalizing device for potential equalization for a plurality of serial batteries provided by the invention is characterized by the batteries are divided into a plurality of groups, one potential equalizer is provided for each group to make potential equalization between batteries, and at least one potential equalizer is provided for different groups to make potential equalization between groups.

The invention provides a hierarchical battery potential equalizing circuit device including a plurality of potential equalizers, which is characterized by the potential equalizers have a hierarchical architecture, the first level of potential equalizers of the hierarchical architecture are for making potential equalization between adjoining single batteries, the other levels of potential equalizers are for making potential equalization between adjoining serial battery set.

The invention provides a hierarchical battery potential equalizing circuit structure for equalizing the potential of a serial battery set, which is characterized by the serial battery set is divided into a plurality of groups, one potential equalizer is provided for each group to make potential equalization between batteries, and at least one potential equalizer is provided for different groups to make potential equalization between groups.

The hierarchical battery potential equalizing device and circuit structure carried out by the invention has fast equalization speed, fast equalization speed for a battery set with high number of batteries, and the design of the circuit for the potential equalizer it used is very easy and the loss of energy transforming is low.

### BRIEF DESCRIPTION OF THE DRAWINGS

FIG. 1 is a circuit structure for a conventional consumptive battery potential equalizing device.

FIG. 2 is a circuit structure for a conventional battery potential equalizing device based on unit amount of electricity distribution.

FIG. 3 is a circuit structure for a conventional distributed battery potential equalizing device based on total amount of electricity distribution.

FIG. 4 is a circuit structure for a conventional centralized battery potential equalizing device based on total amount of electricity distribution.

FIG. 5 is a hierarchical battery potential equalizing circuit structure according to the invention.

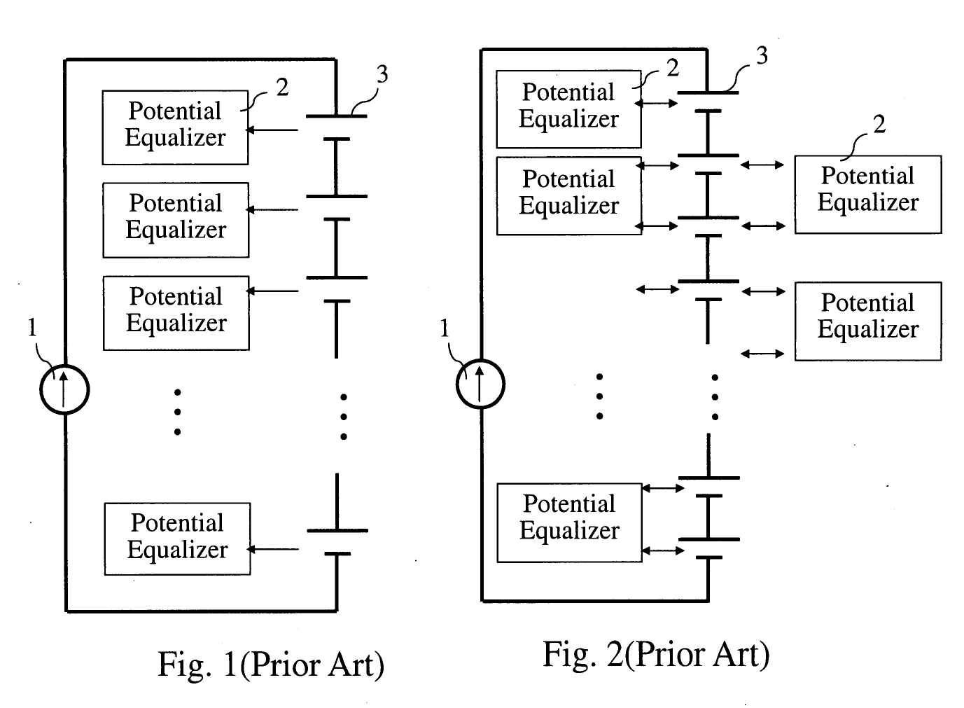

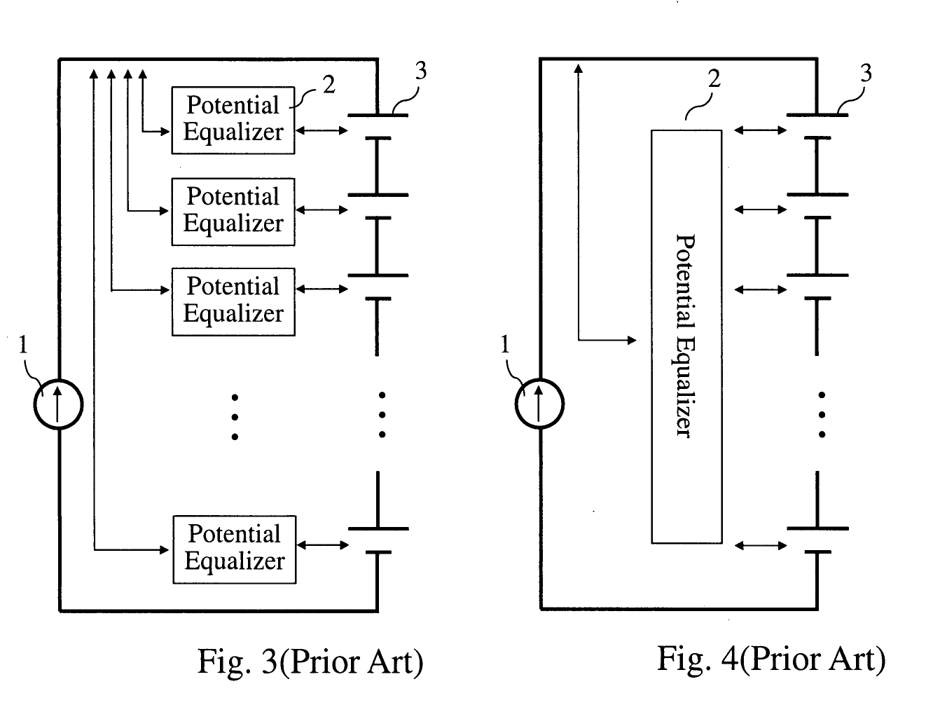

### DETAILED DESCRIPTION OF THE EMBODIMENTS

Although the invention is described in full referring to the accompanying drawings of the preferred embodiment of the invention, prior to the description, it should be understood that those skilled in the art could make modification to the invention described herein, while the performance of the invention is also achieved. Thus, it should be understood, for those skilled in the art, the following description is only a general disclosure and the invention is not limited to its content.

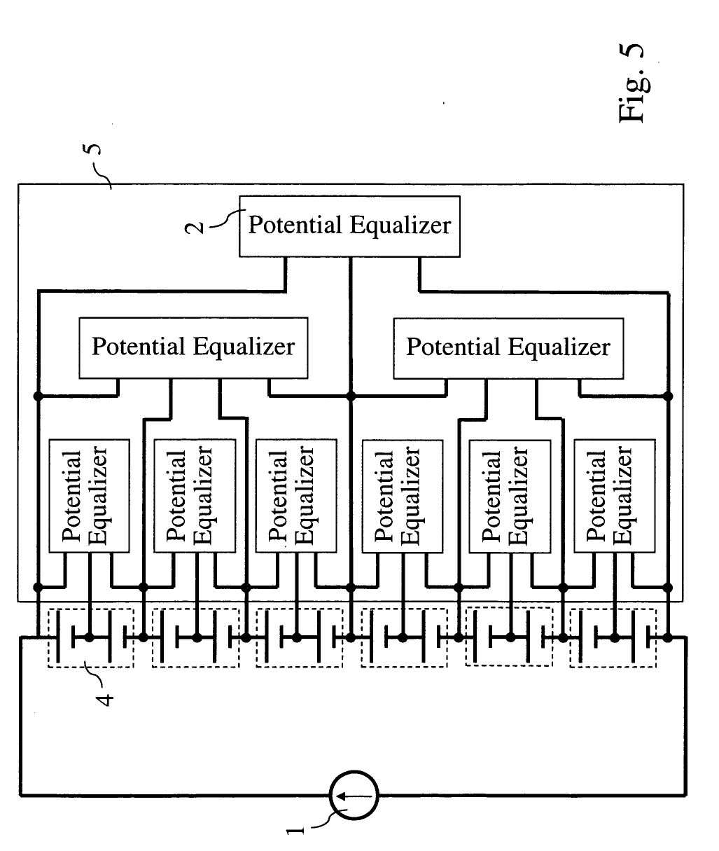

Referring to FIG. 5, a hierarchical battery potential equalizing circuit structure according to the invention is shown. The battery potential equalizing device according to the invention includes a plurality of potential equalizers, and it is suitable for use in serial batteries with high number of batteries. The potential equalizers have a hierarchical architecture 5, the first level (the most bottom level) of potential equalizers 2 of the hierarchical architecture is for making potential equalization between adjoining single batteries, and the other levels of potential equalizer 2 are for making potential equalization between adjoining serial battery sets 4(or groups), wherein the number of batteries in the serial battery set 4(group) equalized by a higher level of potential equalizers 2 is more than that in the serial battery set 4(group) equalized by a lower level of potential equalizers 2.

In the embodiment illustrated in FIG. 5, a battery potential equalizing device according to the invention includes nine potential equalizers for making potential equalization for twelve serial battery sets, wherein the potential equalizers form a three-level hierarchical architecture 5. The first level of potential equalizers are for making potential equalization between two serial single batteries respectively, and these two serial batteries are regarded as a group 4, therefore, the first level of potential equalizers 2 are respectively corresponding to one group to equalize the potential between single batteries. The second level of potential equalizers 2 are respectively corresponding to three groups 4 to make potential equalization, in other words, the second level of potential equalizers 2 equalize the potential between three serial battery sets. The third level of potential equalizers are for making potential equalization between groups for two main groups of batteries, in other words, the third level of potential equalizers will equalize the potential between two serial battery sets (each serial battery set is consisted of six serial batteries).

In the hierarchical battery potential equalizing device and circuit structure carried out by the invention, by the example illustrated in FIG. 5, the first level and the third level of potential equalizers respectively equalize the potential between two single batteries and two main groups of batteries, and the second level of potential equalizers equalize the potential between two groups of batteries, therefore, the design of the circuit is very easy and the loss of energy transforming is low, and the hierarchal architecture makes the potential equalizing device achieve fast equalization.

The technology of the invention can apply to various types of batteries, such as lithium battery, lead acid battery, etc., and can apply to serial batteries with high number of batteries, such as distributed power system, recycle energy, etc. And the potential equalizers included in the battery potential equalizing device and circuit structure according to the invention can select different types of circuits, such as mixed consumptive and non-consumptive potential equalizers, for different application fields.

After the detail description of the preferred embodiment of the invention, those skilled in the art may understand that various modifications and changes can be made without departing from the scope and spirit of the appended claims. Moreover, the invention is not restricted to the implementations of the embodiment cited in the specification, for example, the number of serial batteries among different groups may be the same or different; the potential equalizers of corresponding groups may utilize consumptive or non-consumptive potential equalizers; each group can be further subdivided into several subgroups, then at least one potential equalizer is used to equalize the potential between subgroups, and the number of serial batteries among different subgroups may be the same or different; the amount of potential need to be equalized by different levels of potential equalizers may be the same or different.

What is claimed is:

1. A hierarchical battery potential equalizing device used for making potential equalization for a plurality of serial batteries, characterized by:
the batteries are divided into a plurality of groups, one potential equalizer is provided for each said group to make potential equalization among batteries, and at least one potential equalizer is provided for different said groups to make potential equalization among said groups.

2. The hierarchical battery potential equalizing device according to claim 1, wherein the number of batteries of each said group is the same.

3. The hierarchical battery potential equalizing device according to claim 1, wherein the number of batteries of different said groups is different.

4. The hierarchical battery potential equalizing device according to claim 1, wherein said potential equalizers are consumptive or non-consumptive potential equalizers.

5. The hierarchical battery potential equalizing device according to claim 1, wherein said group is further subdivided into several subgroups, and at least one potential equalizer is used to equalize the potential between said subgroups

6. The hierarchical battery potential equalizing device according to claim 5, wherein the number of batteries of each said subgroup is the same.

7. The hierarchical battery potential equalizing device according to claim 5, wherein the number of batteries of different said subgroups is different.

8. The hierarchical battery potential equalizing device according to claim 1, wherein the potential equalizers form a hierarchical architecture, and the most bottom level of potential equalizers are respectively corresponding to one said group to make potential equalization among single batteries.

9. The hierarchical battery potential equalizing device according to claim 8, wherein the other levels of potential equalizers make potential equalization among said groups respectively.

10. The hierarchical battery potential equalizing device according to claim 8, wherein the number of serial batteries equalized by a higher level of potential equalizers is more than that equalized by a lower level of potential equalizers.

11. A hierarchical battery potential equalizing device including a plurality of potential equalizers, characterized by:
the potential equalizers have a hierarchical architecture, the first level of potential equalizers of the hierarchical architecture are for making potential equalization between adjoining single batteries, the other levels of potential equalizers are for making potential equalization among serial battery sets.

12. The hierarchical battery potential equalizing device according to claim 11, wherein the first level of potential equalizers are respectively corresponding to one said group, and each said group is consisted of several serial batteries.

13. The hierarchical battery potential equalizing device according to claim 12, wherein the number of batteries of each said group is the same.

14. The hierarchical battery potential equalizing device according to claim 12, wherein the number of batteries of different said groups is different.

15. The hierarchical battery potential equalizing device according to claim 11, wherein said potential equalizers are consumptive or non-consumptive potential equalizers.

16. The hierarchical battery potential equalizing device according to claim 12, wherein said group is further subdivided into several subgroups, and at least one potential equalizer is used to equalize the potential among said subgroups.

17. The hierarchical battery potential equalizing device according to claim 16, wherein the number of batteries of each said subgroup is the same.

18. The hierarchical battery potential equalizing device according to claim 16, wherein the number of batteries of different said subgroups is different.

19. The hierarchical battery potential equalizing device according to claim 11, wherein the number of serial batteries equalized by a higher level of potential equalizers is more than that equalized by a lower level of potential equalizers.

20. A hierarchical battery potential equalizing circuit structure used for equalizing the potential of a serial battery set, characterized by:
the serial battery set is divided into a plurality of groups, one potential equalizer is provided for each said group to make potential equalization among batteries, and at least one potential equalizer is provided for different said groups to make potential equalization among said groups.

21. The hierarchical battery potential equalizing circuit structure according to claim 20, wherein the number of batteries of each said group is the same.

22. The hierarchical battery potential equalizing circuit structure according to claim 20, wherein the number of batteries of different said groups is different.

23. The hierarchical battery potential equalizing circuit structure according to claim 20, wherein said potential equalizers are consumptive or non-consumptive potential equalizers.

24. The hierarchical battery potential equalizing circuit structure according to claim 20, wherein said group is further subdivided into several subgroups, and at least one potential equalizer is used to equalize the potential between said subgroups

25. The hierarchical battery potential equalizing circuit structure according to claim 24, wherein the number of batteries of each said subgroup is the same.

26. The hierarchical battery potential equalizing circuit structure according to claim 24, wherein the number of batteries of different said subgroups is different.

27. The hierarchical battery potential equalizing circuit structure according to claim 20, wherein the potential equalizers form a hierarchical architecture, and the most bottom level of potential equalizers are respectively corresponding to one said group to make potential equalization among single batteries.

28. The hierarchal battery potential equalizing circuit structure according to claim 27, wherein the other levels of potential equalizers make potential equalization among said groups respectively.

29. The hierarchical battery potential equalizing circuit structure according to claim 27, wherein the number of serial batteries equalized by a higher level of potential equalizers is more than that equalized by a lower level of potential equalizers.
